(19) United States
(12) Patent Application Publication
(10) Pub. No.: US 2015/0136281 A1
(43) Pub. Date: May 21, 2015

(54) COPPER ALLOY WIRE AND COPPER ALLOY WIRE MANUFACTURING METHOD

(71) Applicants: Hitoshi Nakamoto, Osaka (JP); Norikazu Ishida, Tokyo (JP); Kazunari Maki, Kitamoto-shi (JP); Hiroyuki Mori, Kitamoto-shi (JP); Tetsuya Ashida, Amagasaki-shi (JP)

(72) Inventors: Hitoshi Nakamoto, Osaka (JP); Norikazu Ishida, Tokyo (JP); Kazunari Maki, Kitamoto-shi (JP); Hiroyuki Mori, Kitamoto-shi (JP); Tetsuya Ashida, Amagasaki-shi (JP)

(73) Assignees: MITSUBISHI CABLE INDUSTRIES, LTD., Tokyo (JP); MITSUBISHI MATERIALS CORPORATION, Tokyo (JP)

(21) Appl. No.: 14/413,581

(22) PCT Filed: Jul. 31, 2012
(86) PCT No.: PCT/JP2012/069491

§ 371 Date: Jan. 8, 2015

(51) Int. Cl. H01B 1/02; C22C 9/06; C22F 1/08

(52) U.S. Cl. CPC H01B 1/026; C22F 1/08; C22C 9/06
USPC 148/685; 148/412

(57) ABSTRACT

A copper alloy wire of the present invention consists of a precipitation strengthening type copper alloy containing Co, P, and Sn, wherein an average grain size of precipitates observed through cross-sectional structure observation immediately after performing an aging heat treatment is equal to or greater than 15 nm and a number of precipitates having grain sizes of equal to or greater than 5 nm is 80% or higher of a total number of observed precipitates, and the copper alloy wire is subjected to cold working after the aging heat treatment.

### CROSS-REFERENCE TO RELATED PATENT APPLICATIONS

This application is a U.S. National Phase application under 35 U.S.C. §371 of International Patent Application No. PCT/JP2012/069491, filed Jul. 31, 2012, which is incorporated by reference in its entirety herein. The International application was published in Japanese on Feb. 6, 2014 as International Publication No. WO/2014/020706 under PCT Article 21(2).

### FIELD OF THE INVENTION

The present invention relates to a copper alloy wire which has excellent electrical conductivity and repeated bending characteristics and is appropriate for a wiring cable of an arm portion of a robot, a hinge portion of a mobile terminal or a PC, and the like, and a copper alloy wire manufacturing method.

### BACKGROUND OF THE INVENTION

Bending, torsion, and the like are repeatedly applied to the above-mentioned wiring cable used in an arm portion of a robot, a hinge portion of a mobile terminal or a PC, and the like. Therefore, it is required that the wiring cable is less likely to be broken even when bending is repeatedly applied thereto (hereinafter, the properties are referred to as repeated bending characteristics). In addition, since a current is applied, high electrical conductivity is also required.

Here, typically, as the wiring cable for applying a current, a copper wire made of tough pitch copper having good electrical conductivity is widely used. However, the strength thereof was low and the repeated bending characteristics were insufficient.

Therefore, for the above-described applications, for example, a copper alloy wire made of a solid solution strengthening type copper alloy such as Sn-containing copper described in Patent Document 1 or an In-containing copper described in Patent Document 2 is used. The solid solution strengthening type copper alloys described in Patent Documents 1 and 2 have high strength; and therefore, the repeated bending characteristics are enhanced compared to the tough pitch copper. Specifically, in a bending resistance test which is an evaluation index of repeated bending characteristics, the number of bends repeated until a break occurs under the same conditions is 1.3 times to 2.5 times of that of the tough pitch copper.

However, recently, due to the reductions in the size and thickness of the arm portion of the robot, the mobile terminal, and the PC, the above-described copper alloy wire requires further improvement in repeated bending characteristics.

Furthermore, as a copper alloy wire having further enhanced bending resistance, for example, copper alloy wires made of a precipitation strengthening type alloy such as Cu—Fe—P alloys described in Patent Documents 3 and 4 and a Cu—Cr—Zr alloy described in Patent Document 5 are proposed.

Such precipitation strengthening type copper alloys can obtain better repeated bending characteristics than the solid solution strengthening type copper alloys by uniformly dispersing precipitates in the matrix phase of copper.

### PRIOR ART DOCUMENTS

### Patent Documents

Patent Document 1: Japanese Patent No. 3348501
Patent Document 2: Japanese Unexamined Patent Application, First Publication No. H09-056632
Patent Document 3: Japanese Unexamined Patent Application, First Publication No. S61-064835
Patent Document 4: Japanese Unexamined Patent Application, First Publication No. S62-214146
Patent Document 5: Japanese Unexamined Patent Application, First Publication No. H11-181560

### Problems to be Solved by the Invention

As a single wire in the wiring cable used in an arm portion of a robot, a hinge portion of a mobile terminal or a PC, an extra fine wire having a diameter of 0.08 mm or less is generally used.

As described above, in the precipitation strengthening type copper alloy, precipitates are precipitated and dispersed by an aging heat treatment to enhance electrical conductivity and strength.

Here, in the case where cold working is performed thereon after the aging heat treatment, it is pointed out that precipitates having small grain sizes are sheared off by dislocations that are generated during the cold working and the precipitates are re-solutionized in the matrix phase of copper; and as a result, the electrical conductivity is decreased. Particularly, as described above, in the case of the extra fine wire having a diameter of 0.08 mm or less, the working ratio of the cold working after the aging heat treatment is high and the electrical conductivity is decreased greatly. Therefore, there is a concern that desired electrical conductivity may not be secured.

The present invention has been made taking the foregoing circumstances into consideration, and an object thereof is to provide a copper alloy wire which is excellent in electrical conductivity and repeated bending characteristics and is appropriate for a wiring cable used in a part to which bending, torsion, and the like are repeatedly applied, such as an arm portion of a robot or a hinge portion of a mobile terminal or a PC, and a method for manufacturing a copper alloy wire.

### SUMMARY OF THE INVENTION

### Means for Solving the Problems

In order to solve the above-described problems, a copper alloy wire according to the present invention consists of a precipitation strengthening type copper alloy containing Co, P, and Sn, wherein an average grain size of precipitates observed through cross-sectional structure observation immediately after performing an aging heat treatment is equal to or greater than 15 nm and a number of precipitates having grain sizes of equal to or greater than 5 nm is 80% or higher of a total number of observed precipitates, and the copper alloy wire is subjected to cold working after the aging heat treatment.

The copper alloy wire according to the present invention described above consists of a precipitation strengthening type copper alloy containing Co, P, and Sn, the average grain size of precipitates observed through cross-sectional structure observation immediately after performing the aging heat treatment is equal to or greater than 15 nm, and the number of precipitates having grain sizes of equal to or greater than 5 nm is 80% or higher of the total number of observed precipitates. Therefore, the number of precipitates which consist of compounds containing Co and P and have small grain sizes is small, and the re-solutionizing of the precipitates in the subsequent cold working can be suppressed; and thereby, electrical conductivity is secured.

That is, the precipitates which are precipitated in the aging heat treatment and consist of compounds containing Co and P with grain sizes of less than 5 nm are sheared off and are further divided by dislocations during the cold working after the aging heat treatment and the precipitates are finally re-solutionized in the matrix phase of copper. Here, in a state before the cold working and after the aging heat treatment, the number of precipitates having grain sizes of less than 5 nm is set to be in a range of less than 20% of the total number of observed precipitates. Thereby, it is possible to suppress the precipitates from being re-solutionized.

In addition, since the average grain size of precipitates consisting of compounds containing Co and P is equal to or greater than 15 nm, precipitates are sufficiently precipitated. Therefore, electrical conductivity can be enhanced, and the enhancement of strength and repeated bending characteristics can be achieved.

Here, it is preferable that the composition of the precipitation strengthening type copper alloy contain: 0.12 mass % or higher to 0.40 mass % or less of Co; 0.040 mass % or higher to 0.16 mass % or less of P; and 0.005 mass % or higher to 0.70 mass % or less of Sn, with the remainder being Cu and unavoidable impurities.

In the copper alloy wire having the above-described composition, the precipitates consisting of compounds containing Co and P are dispersed in the matrix phase of copper; and therefore, it is possible to achieve the enhancement of strength and electrical conductivity.

In addition, in the case where the Co content and the P content are lower than the lower limits, the number of precipitates is insufficient; and thereby, strength and repeated bending characteristics cannot be sufficiently enhanced. On the contrary, in the case where the Co content and the P content are higher than the upper limits, a large number of elements that do not contribute to the enhancement of strength are present, and there is concern that a reduction in electrical conductivity and the like may be caused. Therefore, it is desirable that the Co content and the P content be set to be in the above-described ranges.

In addition, Sn is an element having an action of being solutionized in the matrix phase of copper and thus enhancing strength. In addition, Sn also has an effect of accelerating the precipitation of precipitates primarily containing Co and P, and Sn can enhance heat resistance and corrosion resistance. In order to reliably achieve these effects, the Sn content needs to be equal to or higher than 0.005 mass %. In addition, in the case where an excessive amount of Sn is added, a reduction in electrical conductivity is caused. Therefore, it is preferable that the Sn content be equal to or less than 0.70 mass %.

In addition, it is preferable that the precipitation strengthening type copper alloy further include: 0.01 mass % or higher to 0.15 mass % or less of Ni.

The copper alloy wire having the above-described composition contains Ni at a content in the above-described range and thus the coarsening of grains can be suppressed; and thereby, strength and repeated bending characteristics can be further enhanced.

In addition, it is preferable that the precipitation strengthening type copper alloy further include one or more selected from 0.002 mass % or higher to 0.5 mass % or less of Zn, 0.002 mass % or higher to 0.25 mass % or less of Mg, 0.002 mass % or higher to 0.25 mass % or less of Ag, and 0.001 mass % or higher to 0.1 mass % or less of Zr.

The copper alloy wire having the above-described composition contains one or more of Zn, Mg, Ag, and Zr at contents in the above-described ranges. Accordingly, such elements form compounds with sulfur (S); and thereby, it is possible to suppress the sulfur (S) from being solutionized in the matrix phase of copper. As a result, it is possible to suppress the deterioration of mechanical properties such as strength and the like.

A copper alloy wire manufacturing method of the present invention is a method for manufacturing a copper alloy wire consisting of a precipitation strengthening type copper alloy containing Co, P, and Sn, and the method includes: an aging heat treatment process; and a cold working process performed after the aging heat treatment process, wherein an average grain size of precipitates observed through cross-sectional structure observation immediately after performing the aging heat treatment process is made to be equal to or greater than 15 nm and a number of precipitates having grain sizes of equal to or greater than 5 nm is made to be 80% or higher of a total number of observed precipitates.

The copper alloy wire manufacturing method according to the present invention described above includes: the aging heat treatment process; and the cold working process performed after the aging heat treatment process, and the average grain size of precipitates observed through cross-sectional structure observation immediately after performing the aging heat treatment process is made to be equal to or greater than 15 nm and the number of precipitates having grain sizes of equal to or greater than 5 nm is made to be 80% or higher of the total number of observed precipitates. Therefore, the precipitates can be suppressed from being re-solutionized in the cold working process. As a result, the copper alloy wire having excellent electrical conductivity can be manufactured.

In addition, a wire stranding working process of stranding together a plurality of copper alloy wires obtained by the cold working process may be included.

In addition, a final heat treatment process may be performed on the copper alloy wires obtained by the cold working process so as to relieve strains. In the final heat treatment process, it is preferable that the heat treatment temperature be equal to or less than 400° C. Moreover, the final heat treatment process may be performed on a copper alloy wire (single wire) and may be performed on a stranded wire after the wire stranding working process.

### Effects of the Invention

According to the present invention, it is possible to provide a copper alloy wire which is excellent in electrical conductivity and repeated bending characteristics and is appropriate for a wiring cable used in a part to which bending, torsion, and the like are repeatedly applied, such as an arm portion of a robot or a hinge portion of a mobile terminal or a PC, and a method for manufacturing a copper alloy wire.

### BRIEF DESCRIPTION OF THE DRAWINGS

FIG. 1 is a flowchart of a method for manufacturing a copper alloy wire of an embodiment of the present invention and a method for manufacturing a cable conductor.

FIG. 2 is a schematic explanatory view of a continuous casting and rolling facility used in the method for manufacturing the copper alloy wire of the embodiment of the present invention and the method for manufacturing the cable conductor.

FIG. 3 is a schematic explanatory view of a bending test method performed in Examples.

### DETAILED DESCRIPTION OF THE INVENTION

### Embodiments for Carrying Out the Invention

Hereinafter, a method for manufacturing a copper alloy wire according to an embodiment of the present invention will be described with reference to the accompanying drawings.

A copper alloy wire of the embodiment is used as an element wire of a wiring cable of an arm portion of a robot or the like.

The wiring cable for the robot includes: a cable conductor made by stranding a plurality of copper alloy wires together; and an insulation covering which covers the outer circumference of the cable conductor.

Here, the copper alloy wire of this embodiment consists of a copper alloy having a composition containing: 0.12 mass % or higher to 0.40 mass % or less of Co; 0.040 mass % or higher to 0.16 mass % or less of P; and 0.005 mass % or higher to 0.70 mass % or less of Sn, with the remainder being Cu and unavoidable impurities.

In addition, the copper alloy may further include 0.01 mass % or higher to 0.15 mass % or less of Ni. In addition, the copper alloy may further include one or more selected from 0.002 mass % or higher to 0.5 mass % or less of Zn, 0.002 mass % or higher to 0.25 mass % or less of Mg, 0.002 mass % or higher to 0.25 mass % or less of Ag, and 0.001 mass % or higher to 0.1 mass % or less of Zr.

Hereinafter, the reason that the content of each of the elements is set to be in the above-described range will be described.

### (Co and P)

Co and P are elements that form precipitates which are dispersed in the matrix phase of copper.

Here, in the case where a Co content is less than 0.12 mass % and a P content is less than 0.04 mass %, the number of precipitates is insufficient and there is concern that strength and repeated bending characteristics may not be sufficiently enhanced. On the contrary, in the case where the Co content is higher than 0.40 mass % and the P content is higher than 0.16 mass %, a large number of elements that do not contribute to the enhancement of strength are present, and there is concern that a reduction in electrical conductivity and the like may be caused.

Therefore, it is desirable that the Co content be set to be in a range of 0.12 mass % or higher to 0.40 mass % or less and the P content be set to be in a range of 0.040 mass % or higher to 0.16 mass % or less.

### (Sn)

Sn is an element having an action of enhancing strength by being solutionized in the matrix phase of copper. In addition, Sn also has an effect of accelerating the precipitation of precipitates primarily containing Co and P and also has an action of enhancing heat resistance and corrosion resistance.

Here, in the case where a Sn content is less than 0.005 mass %, there is concern that the above-described effect may not be reliably achieved. On the contrary, in the case where the Sn content is higher than 0.70 mass %, there is concern that electrical conductivity may not be secured.

Therefore, it is desirable that the Sn content be se to be in a range of 0.005 mass % or higher to 0.70 mass % or less.

### (Ni)

Ni can replace a portion of Co, and Ni is an element having an effect of suppressing the coarsening of grains.

Here, in the case where a Ni content is less than 0.01 mass %, there is concern that the above-described effect may not be reliably achieved. On the contrary, in the case where the Ni content is higher than 0.15 mass %, there is concern that electrical conductivity may not be secured.

Therefore, in the case where Ni is contained, it is preferable that the Ni content be in a range of 0.01 mass % or higher to 0.15 mass % or less.

### (Zn, Mg, Ag, and Zr)

Zn, Mg, Ag, and Zr are elements that produce compounds with sulfur (S) and have an effect of suppressing the sulfur (S) from being solutionized in the matrix phase of copper.

Here, in the case where the contents of the elements Zn, Mg, Ag, and Zr are less than the above-described lower limits, the effect of suppressing the sulfur (S) from being solutionized in the matrix phase of copper cannot be sufficiently achieved. On the contrary, in the case where the contents of the elements Zn, Mg, Ag, and Zr are higher than the above-described upper limits, there is concern that electrical conductivity may not be secured.

Therefore, in the case where the elements Zn, Mg, Ag, and Zr are contained, it is preferable that the contents of the elements be in the above-described ranges.

Here, in the copper alloy wire of this embodiment, the average grain size of precipitates observed through cross-sectional structure observation immediately after performing an aging heat treatment process S03, which will be described later, is equal to or greater than 15 nm, and the number of precipitates having grain sizes of equal to or greater than 5 nm is 80% or higher of the total number of observed precipitates. In addition, the copper alloy wire is manufactured by performing cold working (a second cold working process S04) after the aging heat treatment process S03.

Here, the precipitates were observed as follows. The precipitates were observed by a transmission electron microscope at magnifications of 150,000 and 750,000, and the area of the corresponding precipitates was calculated and an equivalent circle diameter was calculated as a grain size. In addition, the precipitates having grain sizes of 11 nm to 100 nm were measured at a magnification of 150,000, and the precipitates having grain sizes of 1 nm to 10 nm were measured at a magnification of 750,000. During the observation at the magnification of 750,000, the precipitates having grain sizes of less than 1 nm cannot be clearly determined, and thus the total number of observed precipitates becomes the number of precipitates having grain sizes of equal to or greater than 1 nm. In addition, the observation by the transmission electron microscope was performed on a visual field area of about 4×10⁵ nm² in the case of the magnification of 150,000 and the observation was performed on a visual field area of about 2×10⁴ nm² in the case of the magnification of 750,000.

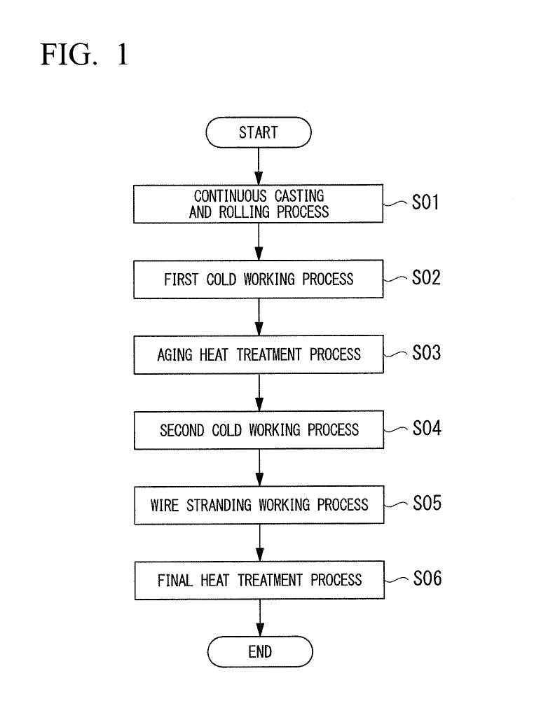

Next, a method for manufacturing the above-described copper alloy wire and a method for manufacturing the cable conductor will be described. FIG. 1 illustrates a flowchart of the method for manufacturing the copper alloy wire of the embodiment of the present invention and the method for manufacturing the cable conductor.

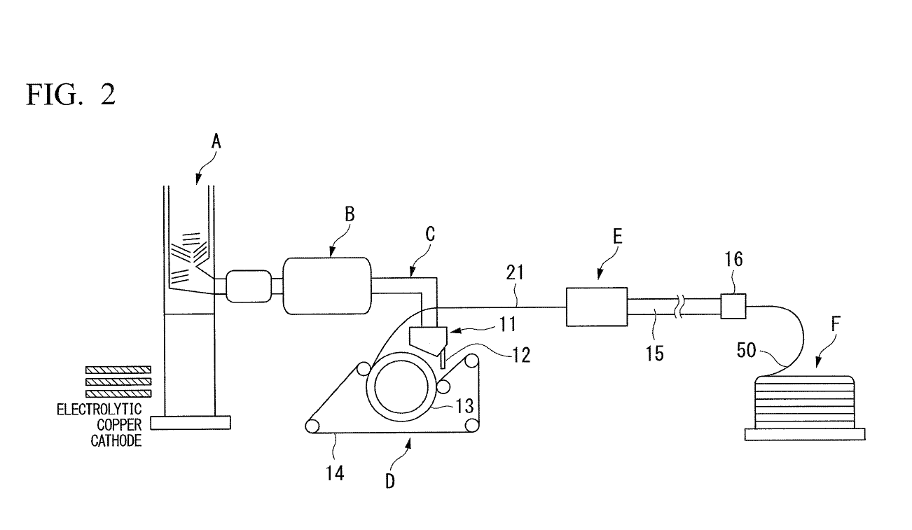

First, a copper wire rod 50 consisting of the above-described copper alloy is continuously produced according to a continuous casting and rolling method (continuous casting and rolling process S01). In the continuous casting and rolling process S01, for example, a continuous casting and rolling facility illustrated in FIG. 2 is used.

The continuous casting and rolling facility illustrated in FIG. 2 includes a melting furnace A, a holding furnace B, a casting launder C, a belt-wheel type continuous casting machine D, a continuous rolling device E, and a coiler F.

In this embodiment, as the melting furnace A, a shaft furnace which includes a cylindrical furnace body is used. A plurality of burners (not illustrated) are arranged in the circumferential direction in the lower part of the furnace body and the burners are arranged in a multi-stage form in the vertical direction. In addition, electrolytic copper cathode which is a raw material is inserted from the upper part of the furnace body and is melted by the combustion of the burners; and thereby, molten copper is continuously produced.

The holding furnace B temporarily stores the molten copper produced in the melting furnace A while being held at a predetermined temperature and the holding furnace B sends a constant amount of the molten copper to the casting launder C.

The casting launder C sends the molten copper sent from the holding furnace B to a tundish 11 disposed above the belt-wheel type continuous casting machine D. The casting launder C is sealed by, for example, an inert gas such as Ar or a reducing gas. In addition, in the casting launder C, a degassing apparatus (not illustrated) for stirring the molten copper using an inert gas to remove oxygen and the like in the molten copper is provided.

The tundish 11 is a storage tank provided to continuously supply the molten copper to the belt-wheel type continuous casting machine D. On the end side of the tundish 11 in the flowing direction of the molten copper, a pouring nozzle 12 is disposed so that the molten copper in the tundish 11 is supplied to the belt-wheel type continuous casting machine D via the pouring nozzle 12.

Here, in this embodiment, an alloy element adding apparatus (not illustrated) is provided in the casting launder C and the tundish 11 to add the above-mentioned elements (Co, P, Sn, and the like) to the molten copper.

The belt-wheel type continuous casting machine D includes: a casting wheel 13 having a groove formed in the outer circumferential surface; and a belt 14 with no ends which revolves and moves so as to come into contact with a part of the outer circumferential surface of the casting wheel 13. In the belt-wheel type continuous casting machine D, the molten copper is poured into a space formed between the groove and the belt 14 with no ends via the pouring nozzle 12, and the molten copper is cooled to solidify; and thereby, a bar-like cast copper 21 is continuously casted.

The continuous rolling device E is connected to the downstream side of the belt-wheel type continuous casting machine D. The continuous rolling device E continuously rolls the cast copper 21 produced from the belt-wheel type continuous casting machine D; and thereby, a copper wire rod 50 having a predetermined outside diameter is produced.

The copper wire rod 50 produced from the continuous rolling device E passes through a washing and cooling device 15 and a flaw detector 16 and is coiled by the coiler F.

Here, the outside diameter of the copper wire rod 50 produced in the continuous casting and rolling facility described above is, for example, equal to or greater than 8 mm and equal to or less than 40 mm, and in this embodiment, the outside diameter is 8 mm.

In addition, in the continuous casting and rolling process S01, the cast copper 21 is held at a relatively high temperature of, for example, 800° C. to 1000° C.; and thereby, a large amount of elements such as Co and P are solutionized in the matrix phase of copper.

Next, as illustrated in FIG. 1, the copper wire rod 50 produced in the continuous casting and rolling process S01 is subjected to cold working (first cold working process S02). In the first cold working process S02, the working is performed in a plurality of stages to form a copper wire material having an outside diameter in a range of equal to or greater than 0.1 mm and equal to or less than 8.0 mm. In this embodiment, the copper wire material has an outside diameter of 0.9 mm.

Next, the copper wire material after the first cold working process S02 is subjected to the aging heat treatment (aging heat treatment process S03). In the aging heat treatment process S03, precipitates consisting of a compound that primarily contains Co and P are precipitated.

Here, in the aging heat treatment process S03, the aging heat treatment is performed under the conditions where a heat treatment temperature is 400° C. or higher and 600° C. or less, and a holding time is 0.5 hour or longer and 6.0 hours or less.

Next, the copper wire material after the aging heat treatment process S03 is subjected to cold working to produce a copper alloy wire having a predetermined cross-sectional shape (second cold working process S04).

In the second cold working process S04, the working is performed in a plurality of stages to form the copper alloy wire having an outside diameter in a range of equal to or greater than 0.015 mm and equal to or less than 0.2 mm. In this embodiment, the copper alloy wire has an outside diameter of 0.08 mm.

Next, a plurality of copper alloy wires (in this embodiment, 40 wires) obtained as described above are stranded together to form a cable conductor (wire stranding working process S05). In this embodiment, the stranding pitch in the wire stranding working process S05 is set to be equal to or greater than 4 mm and equal to or less than 24 mm.

In addition, for the purpose of relieving strains, the cable conductor obtained in the wire stranding working process S05 is subjected to a batch type heat treatment of holding the cable conductor at a temperature of 100° C. or higher and 400° C. or less for 30 minutes or longer and 300 minutes or less is performed (final heat treatment process S06).

In the final heat treatment process S06, various methods other than the batch type heat treatment may also be used such as a heat treatment where a tubular furnace through which a wire material passes is used, conductive annealing, and the like.

According to the copper alloy wire of this embodiment configured as described above, the average grain size of precipitates observed through cross-sectional structure observation immediately after performing the aging heat treatment process S03 is equal to or greater than 15 nm, and the number of precipitates having grain sizes of equal to or greater than 5 nm is 80% or higher of the total number of observed precipitates. Therefore, the number of precipitates having small grain sizes is small and the precipitates can be suppressed from being re-solutionized in the subsequent second cold working process S04. Thereby, it is possible to manufacture the copper alloy wire having excellent electrical conductivity.

In addition, since the average grain size of precipitates is equal to or greater than 15 nm, precipitates are sufficiently precipitated. Therefore, electrical conductivity can be enhanced and the enhancement of strength and repeated bending characteristics can be achieved.

Accordingly, the wiring cable can be used in a part to which bending, torsion, and the like are repeatedly applied, such as an arm portion of a robot and the like.

In this embodiment, since the composition of the copper alloy wire contains: 0.12 mass % or higher to 0.40 mass % or less of Co; 0.040 mass % or higher to 0.16 mass % or less of P; and 0.005 mass % or higher to 0.70 mass % or less of Sn, with the remainder being Cu and unavoidable impurities, precipitates consisting of compounds primarily containing Co and P are dispersed in the matrix phase of copper. Accordingly, it is possible to achieve the enhancement of strength and electrical conductivity. In addition, since Sn is contained at a content in a range of 0.005 mass % or higher to 0.70 mass % or less, the strength can further be enhanced by solid solution strengthening. Accordingly, strength and repeated bending characteristics can be enhanced. In addition, heat resistance and corrosion resistance are also enhanced.

Furthermore, in this embodiment, since 0.01 mass % or higher to 0.15 mass % or less of Ni is further contained, the coarsening of grains can be suppressed; and thereby, strength and repeated bending characteristics can be further enhanced.

In addition, in this embodiment, since one or more selected from 0.002 mass % or higher to 0.5 mass % or less of Zn, 0.002 mass % or higher to 0.25 mass % or less of Mg, 0.002 mass % or higher to 0.25 mass % or less of Ag, and 0.001 mass % or higher to 0.1 mass % or less of Zr are contained, the elements such as Zn, Mg, Ag, and Zr form compounds with sulfur (S); and thereby, it is possible to suppress the sulfur (S) from being solutionized in the matrix phase of copper. As a result, it is possible to suppress the deterioration of mechanical properties such as the strength and the like of the copper alloy wire.

In addition, in this embodiment, the method includes: the wire stranding working process S05 of stranding a plurality of copper alloy wires together to form a cable conductor after the second cold working process S04; and the final heat treatment process S06 of subjecting the cable conductor to a heat treatment for relieving strains. Therefore, strains accumulated in the second cold working process S04 and the wire stranding working process S05 can be relieved through the final heat treatment process S06, and thus, it is possible to enhance bending properties, elongation, and the like. In addition, in the final heat treatment process S06, since the heat treatment temperature is set to be in a range of 100° C. or higher and 400° C. or less, there is no concern regarding copper alloy wires coming into close contact with each other.

In addition, in this embodiment, since the copper wire rod 50 is produced in the continuous casting and rolling process S01, the copper wire rod 50 can be efficiently produced. In addition, since the copper wire rod 50 is held for a predetermined time in a high temperature state of, for example, 800 to 1000° C., the elements such as Co, P, and the like are solutionized in the matrix phase of copper. Accordingly, it is not necessary to conduct an additional solutionizing treatment.

While the embodiment of the present invention has been described, the present invention is not limited thereto, and modifications can be appropriately made without departing from the technical features of the present invention.

For example, in this embodiment, the copper alloy wire that forms a wiring cable for a robot is described. However, the embodiment is not limited thereto, and a wiring cable used in a hinge portion or the like of a mobile terminal or a PC may also be applied.

In addition, in this embodiment, the copper wire rod is manufactured by the continuous casting and rolling process in the description. However, the embodiment is not limited thereto, and a columnar ingot (billet) may be produced and the ingot may be extruded and cold-worked to produce the copper wire rod. In the case where the copper wire rod is produced by the extrusion method, it is necessary to perform an additional solutionizing treatment. Moreover, even in the case where the copper wire rod is manufactured by the continuous casting and rolling process, the copper wire rod may also be subjected to a solutionizing treatment.

In addition, in this embodiment, the continuous casting and rolling process is performed by using the belt-wheel type continuous casting machine illustrated in FIG. 2 in the description. However, the embodiment is not limited thereto, and another continuous casting method may also be employed.

### Examples

Hereinafter, the results of a confirmation test performed to check the effectiveness of the present invention will be described.

### Invention Examples and Comparative Examples

By using a continuous casting and rolling facility provided with a belt-wheel type continuous casting machine, a copper wire rod (a diameter of 8 mm) consisting of a copper alloy having the composition shown in Table 1 was produced. First cold working was performed on the copper wire rod so as to have a diameter of 0.9 mm, and then an aging heat treatment was performed on the resultant under the conditions shown in Table 1. Thereafter, second cold working was performed thereon so as to have a diameter of 0.08 mm and a final heat treatment was performed thereon under the conditions shown in Table 1.

### RELATED ART EXAMPLES

As Related Art Example 1, tough pitch copper having an outside diameter of 0.08 mm, which was soft copper, was prepared.

As Related Art Example 2, Sn-containing copper having an outside diameter of 0.08 mm, which was hard copper, was prepared.

As Related Art Example 3, Sn-containing copper having an outside diameter of 0.08 mm, which was soft copper, was prepared.

(Observation of Precipitates after Aging Heat Treatment)

In Invention Examples, the precipitates were observed by using copper wire materials after the aging heat treatment. The observation of the precipitates was performed by using a transmission electron image of a transmission electron microscope (model name: TEM: H-800, HF-2000, and HF-2200 manufactured by Hitachi, Ltd., and SEM-2010F manufactured by JEOL Ltd.), and an equivalent grain size was calculated from the area of each precipitate. In addition, the observation was performed at magnifications of 150,000 and 750,000 on visual field areas of about 4×10⁵ nm² and about 2×10⁴ nm², respectively. In addition, the average grain size of the precipitates and the ratio of precipitates having grain sizes of equal to or greater than 5 nm to the observed precipitates were calculated. The results are shown in Table 2.

### (Bending Properties)

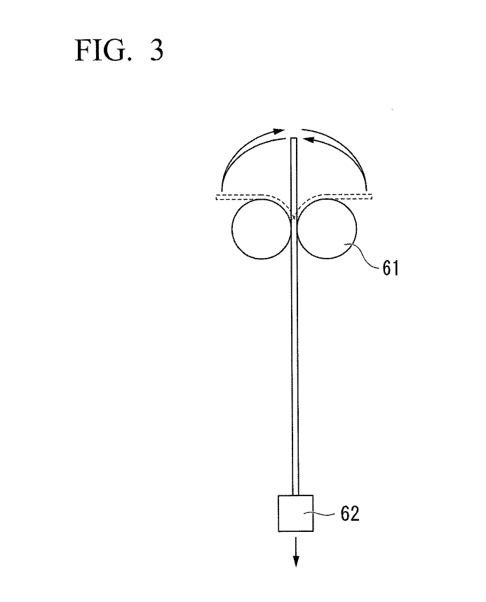

Bending properties were evaluated using the copper alloy wires (outside diameter of 0.08 mm) of Invention Examples, Comparative Examples, and Related Art Examples. The bending property test was conducted by a bending test method illustrated in FIG. 3. The R of a bending portion 61 was set to 5 mm, the load (weight 62) was set to 20 g, and the number of returns to the original position after bending at 180° was set to 2. Bending was repeated until a break occurred. The evaluation results are shown in Table 2.

### (Electrical Conductivity)

Electrical conductivity was measured using the copper alloy wires (outside diameter of 0.08 mm) of Invention Examples, Comparative Examples, and Related Art Examples after the final heat treatment. The electrical conductivity was measured on the basis of JIS H 0505 according to a double bridge method. The evaluation results are shown in Table 2.

TABLE 1

| | | | | | | | | | Aging heat treatment | | Final heat treatment | |
|---|---|---|---|---|---|---|---|---|---|---|---|---|
| | Composition (wt %) | | | | | | | | Temperature | Time | Temperature | Time |
| | Co | P | Sn | Ni | Zn | Mg | Ag | Zr | (° C.) | (min) | (° C.) | (min) |
| Invention | 0.13 | 0.08 | 0.04 | — | — | — | — | — | 550 | 60 | 400 | 30 |
| Example 1 | | | | | | | | | | | | |
| Invention | 0.25 | 0.078 | 0.03 | — | — | — | — | — | 500 | 120 | 300 | 60 |
| Example 2 | | | | | | | | | | | | |
| Invention | 0.38 | 0.082 | 0.04 | — | — | — | — | — | 475 | 150 | 300 | 60 |
| Example 3 | | | | | | | | | | | | |
| Invention | 0.24 | 0.06 | 0.04 | — | — | — | — | — | 450 | 180 | 275 | 90 |
| Example 4 | | | | | | | | | | | | |
| Invention | 0.27 | 0.14 | 0.03 | — | — | — | — | — | 525 | 90 | 325 | 50 |
| Example 5 | | | | | | | | | | | | |
| Invention | 0.26 | 0.077 | 0.006 | — | — | — | — | — | 550 | 60 | 300 | 60 |
| Example 6 | | | | | | | | | | | | |
| Invention | 0.24 | 0.081 | 0.68 | — | — | — | — | — | 500 | 120 | 250 | 120 |
| Example 7 | | | | | | | | | | | | |
| Invention | 0.22 | 0.091 | 0.04 | 0.02 | — | — | — | — | 550 | 60 | 300 | 60 |
| Example 8 | | | | | | | | | | | | |
| Invention | 0.24 | 0.077 | 0.03 | 0.04 | — | — | — | — | 525 | 90 | 250 | 120 |
| Example 9 | | | | | | | | | | | | |
| Invention | 0.25 | 0.078 | 0.04 | 0.13 | 0.015 | — | — | — | 450 | 180 | 325 | 50 |
| Example 10 | | | | | | | | | | | | |
| Invention | 0.23 | 0.077 | 0.04 | 0.04 | 0.005 | — | — | — | 550 | 60 | 300 | 60 |
| Example 11 | | | | | | | | | | | | |
| Invention | 0.31 | 0.097 | 0.05 | 0.04 | — | 0.05 | — | — | 550 | 60 | 300 | 60 |
| Example 12 | | | | | | | | | | | | |
| Invention | 0.24 | 0.075 | 0.1 | 0.05 | — | — | 0.03 | 0.025 | 525 | 90 | 250 | 120 |
| Example 13 | | | | | | | | | | | | |
| Invention | 0.1 | 0.078 | 0.05 | — | — | — | — | — | 550 | 60 | 400 | 30 |
| Example 14 | | | | | | | | | | | | |
| Invention | 0.43 | 0.075 | 0.04 | — | — | — | — | — | 475 | 150 | 250 | 120 |
| Example 15 | | | | | | | | | | | | |
| Invention | 0.22 | 0.03 | 0.04 | — | — | — | — | — | 500 | 120 | 300 | 60 |
| Example 16 | | | | | | | | | | | | |
| Invention | 0.24 | 0.18 | 0.03 | — | — | — | — | — | 550 | 60 | 300 | 60 |
| Example 17 | | | | | | | | | | | | |
| Invention | 0.26 | 0.077 | 0.004 | — | — | — | — | — | 525 | 90 | 275 | 90 |
| Example 18 | | | | | | | | | | | | |
| Invention | 0.28 | 0.075 | 0.75 | — | — | — | — | — | 500 | 120 | 250 | 120 |
| Example 19 | | | | | | | | | | | | |
| Comparative | 0.25 | 0.078 | 0.04 | 0.04 | 0.015 | — | — | — | 375 | 20 | 90 | 330 |
| Example 1 | | | | | | | | | | | | |
| Comparative | 0.3 | 0.094 | 0.05 | 0.04 | 0.015 | — | — | — | 350 | 400 | 95 | 330 |
| Example 2 | | | | | | | | | | | | |
| Comparative | 0.21 | 0.066 | 0.1 | 0.05 | 0.014 | — | — | — | 360 | 250 | 150 | 60 |
| Example 3 | | | | | | | | | | | | |

| | | | | | |
|---|---|---|---|---|---|
| Related Art | Tough pitch copper | — | — | — | — |
| Example 1 | (diameter of 0.08 mm, soft copper wire) | | | | |
| Related Art | 0.3 mass % Sn-containing copper | — | — | — | — |
| Example 2 | (diameter of 0.08 mm, hard copper wire) | | | | |
| Related Art | 0.3 mass % Sn-containing copper | — | — | — | — |
| Example 3 | (diameter of 0.08 mm, soft copper wire) | | | | |

TABLE 2

| | Observation results of | | | |
|---|---|---|---|---|
| | precipitates after aging | | | |
| | heat treatment | | Bending | |
| | Average | Ratio of | property | Electrical |
| | grain | 5 nm or | test | conductivity |
| | size (nm) | greater (%) | (times) | (% IACS) |
| Invention Example 1 | 18 | 88 | 1221 | 89.2 |
| Invention Example 2 | 21 | 90 | 2013 | 77.5 |
| Invention Example 3 | 22 | 93 | 1936 | 75.4 |
| Invention Example 4 | 25 | 96 | 1802 | 74.5 |
| Invention Example 5 | 24 | 95 | 2121 | 76.5 |
| Invention Example 6 | 22 | 91 | 1754 | 83.0 |
| Invention Example 7 | 29 | 97 | 2743 | 74.5 |
| Invention Example 8 | 24 | 95 | 2349 | 79.0 |
| Invention Example 9 | 30 | 98 | 2431 | 81.2 |
| Invention Example 10 | 30 | 95 | 2450 | 80.8 |
| Invention Example 11 | 21 | 92 | 2398 | 80.1 |
| Invention Example 12 | 24 | 93 | 2654 | 78.5 |
| Invention Example 13 | 21 | 91 | 2540 | 79.4 |
| Invention Example 14 | 22 | 94 | 954 | 87.5 |
| Invention Example 15 | 26 | 97 | 1012 | 76.4 |
| Invention Example 16 | 31 | 96 | 845 | 69.0 |
| Invention Example 17 | 21 | 92 | 949 | 74.5 |
| Invention Example 18 | 24 | 95 | 899 | 77.1 |
| Invention Example 19 | 22 | 93 | 1154 | 71.9 |
| Comparative | 13 | 75 | 670 | 61.9 |
| Example 1 | | | | |
| Comparative | 9 | 71 | 715 | 59.8 |
| Example 2 | | | | |
| Comparative | 10 | 73 | 728 | 63.4 |
| Example 3 | | | | |
| Related Art Example 1 | — | — | 285 | 100.1 |
| Related Art Example 2 | — | — | 429 | 78 |
| Related Art Example 3 | — | — | 540 | 84.4 |

In all the Invention Examples 1 to 19, it was confirmed that the average grain size of precipitates observed through cross-sectional structure observation immediately after performing the aging heat treatment was equal to or greater than 15 nm, and the number of precipitates having grain sizes of equal to or greater than 5 nm was 80% or higher of the total number of the observed precipitates. The bending properties were better than those of Related Art Examples 1 and 2, and the electrical conductivity thereof was equal to or higher than 70% IACS.

On the contrary, in Comparative Examples 1 to 3 in which the number of precipitates having grain sizes of equal to or greater than 5 nm was less than 80% of the total number of the observed precipitates (in Comparative Examples 2 and 3, the average grain size of precipitates was less than 15 nm), bending properties and electrical conductivity were poor.

From the above results, according to the Invention Examples, it was confirmed that copper alloy wires excellent in electrical conductivity and repeated bending characteristics could be obtained.

### INDUSTRIAL APPLICABILITY

The present invention relates to a copper alloy wire which is excellent in electrical conductivity and repeated bending characteristics and is appropriate for a wiring cable used in a part to which bending, torsion, and the like are repeatedly applied, such as an arm portion of a robot or a hinge portion of a mobile terminal or a PC, and a copper alloy wire manufacturing method.

1. A copper alloy wire consisting of:
a precipitation strengthening type copper alloy containing Co, P, and Sn,
wherein an average grain size of precipitates observed through cross-sectional structure observation immediately after performing an aging heat treatment is equal to or greater than 15 nm and a number of precipitates having grain sizes of equal to or greater than 5 nm is 80% or higher of a total number of observed precipitates, and
the copper alloy wire is subjected to cold working after the aging heat treatment.

2. The copper alloy wire according to claim 1, wherein a composition of the precipitation strengthening type copper alloy comprises:
0.12 mass % or higher to 0.40 mass % or less of Co;
0.040 mass % or higher to 0.16 mass % or less of P; and
0.005 mass % or higher to 0.70 mass % or less of Sn, with the remainder being Cu and unavoidable impurities.

3. The copper alloy wire according to claim 2, wherein the precipitation strengthening type copper alloy further comprises:
0.01 mass % or higher to 0.15 mass % or less of Ni.

4. The copper alloy wire according to claim 2, wherein the precipitation strengthening type copper alloy further comprises one or more selected from 0.002 mass % or higher to 0.5 mass % or less of Zn, 0.002 mass % or higher to 0.25 mass % or less of Mg, 0.002 mass % or higher to 0.25 mass % or less of Ag, and 0.001 mass % or higher to 0.1 mass % or less of Zr.

5. A method for manufacturing a copper alloy wire consisting of a precipitation strengthening type copper alloy containing Co, P, and Sn, the method comprising:
an aging heat treatment process; and
a cold working process performed after the aging heat treatment process,
wherein an average grain size of precipitates observed through cross-sectional structure observation immediately after performing the aging heat treatment process is made to be equal to or greater than 15 nm and a number of precipitates having grain sizes of equal to or greater than 5 nm is made to be 80% or higher of a total number of observed precipitates.

6. The copper alloy wire according to claim 3, wherein the precipitation strengthening type copper alloy further comprises one or more selected from 0.002 mass % or higher to 0.5 mass % or less of Zn, 0.002 mass % or higher to 0.25 mass % or less of Mg, 0.002 mass % or higher to 0.25 mass % or less of Ag, and 0.001 mass % or higher to 0.1 mass % or less of Zr.
